(19) United States
(12) Patent Application Publication
(10) Pub. No.: US 2006/0158426 A1
(43) Pub. Date: Jul. 20, 2006

(54) Display apparatus with input devices

(75) Inventor: Yasuji Hagiwara, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/332,595

(22) Filed: Jan. 13, 2006

(30) Foreign Application Priority Data
Jan. 14, 2005 (JP) 2005-007137

(51) Int. Cl. G09G 5/00

(52) U.S. Cl. 345/156

(57) ABSTRACT

A display apparatus with input devices includes a display unit including a liquid crystal display and a frame surrounding the periphery of the display unit. The input devices that are disposed on the frame are being used to switch a switching circuit when touched by an operator. A plurality of menu items corresponding to a plurality of function menus is displayable on the display unit. A predetermined function menu is started and/or selected by operating the input devices provided at a position corresponding to a predetermined menu item displayed on the display unit.

### BACKGROUND OF THE INVENTION

1. Field of the Invention

The present invention relates to a portable display apparatus with input devices and, more specifically, relates to a portable display apparatus with input devices allowing modes of a function menu to be switched by operating the input devices provided on a frame in the vicinity of a menu itemed on a display unit.

2. Description of the Related Art

As described in Japanese Unexamined Patent Application Publication No. 2000-322046, a known portable display apparatus 31 with an input device includes a display unit 32 and a frame 33 surrounding the periphery of the display unit 32, and an input device 34 including a slide pad is provided in the lower area of the electric oven unit 33, as shown in FIG. 5.

To operate such a known portable display apparatus 31 with the input device, the operator touches the surface of the input device 34 with their finger to display a main menu 35 on the display unit 32, as shown in FIG. 6. The main menu 35 includes a plurality of menu item icons 35a to 35k that can be operated to adjust, for example, brightness, contrast, size, and distortion.

To adjust the horizontal position of the image displayed on the display unit 32, the operator touches the input device 34 to display the main menu 35 on the display unit 32. Then, by sliding their finger in contact with the input device 34, a cursor 36 on the display unit 32 is moved onto the menu item icon 35c for size and position adjustment.

In this state, by tapping on the surface of the input device 34, the main menu 35 is switched to an adjustment screen 37 for horizontal position adjustment, as shown in FIG. 7.

Furthermore, the cursor 36 is moved onto a horizontal adjustment icon 38 on the adjustment screen 37 horizontal position adjustment, and, then, the surface of the input device 34 is tapped.

In response to the tapping, a scroll bar 39 is displayed. Then, the operator slides their finger on the input device 34 to adjust the horizontal position of the image displayed on the display unit 32.

When the image has been adjusted to a desirable position, the surface of the input device 34 may be tapped with the cursor 36 aligned with an icon 40, shown in the lower right area in FIG. 7, so as to turn off the adjustment screen 37 horizontal position adjustment. In this way, all parts of the image displayed on the display unit 32 will be made visible.

As described above, according to the known display apparatus with input devices, the input device 34 is disposed only on one side in the lower area of the frame 33. Therefore, when adjustment is carried out for a plurality of function menus, the cursor 36 has to be moved on a predetermined menu item for each adjustment, causing the operation to be complicated.

Since the input device 34 is operated to move the cursor 36, in case the portable display apparatus 31 is a portable apparatus, it is difficult to align the cursor 36 with the predetermined menu item.

### SUMMARY OF THE INVENTION

The present invention solves the above-described problems and provides a display apparatus with input devices that can be easily operated since input devices are provided on at least two sides of the frame surrounding the display unit and menu items corresponding to function menus are displayed on the display unit.

To solve the above-described problem, a display apparatus with input devices according to a first aspect of the present invention includes a display unit including a liquid crystal display and a frame surrounding the periphery of the display unit, wherein, the input devices, which are disposed on the frame, are capable of switching a switching circuit when touched by an operator, a plurality of menu items corresponding to a plurality of function menus are displayable on the display unit, and a predetermined function menu is started and/or selected by operating the input devices provided at a position corresponding to a predetermined menu item displayed on the display unit.

To solve the above-described problem, in a display apparatus with input devices according to a second aspect of the present invention, the input devices having predetermined dimensions and thicknesses are partially embedded in the frame and operation surfaces provided on the surfaces of the input devices are surrounded by guide protrusions having a predetermined height.

To solve the above-described problem, in a display apparatus with input devices according to a third aspect of the present invention, the menu item displayed on the display unit includes icons displayed close to the outer periphery of the display unit and in the vicinity of at least one of the input devices provided on the frame, and a menu list corresponding to function menus is displayed on the display unit by operating at least one of the input devices provided in the vicinity of the predetermined icons so as to start up the predetermined function menu corresponding to a predetermined icon.

To solve the above-described problem, in a display apparatus with input devices according to a fourth aspect of the present invention, wherein a predetermined menu is selected from the menu list by operating at least one of the input devices in the vicinity of the predetermined icon again after the menu list is displayed.

To solve the above-described problem, in a display apparatus with input devices according to a fifth aspect of the present invention, the frame has a rectangular shape, the input devices provided on the frame are long and are disposed along at least two sides of the frame adjacent and orthogonal to each other in the X and Y directions, the plurality of menu items displayed on the display unit include a displayed list of the function menus aligned along the X direction and the Y direction of the display unit, and a predetermined function menu is selected from the plurality of function menus by operating at least two of the input devices in the list display in the X direction and the Y direction, the input devices corresponding to a predetermined menu item in the displayed list.

To solve the above-described problem, in a display apparatus with input devices according to a sixth aspect of the present invention, wherein the display size of the function menus included in the displayed list displayed on the display unit is adjustable by operating the input devices.

Since according to the display apparatus with input devices according to the present invention, the input devices, which are disposed on the frame, are being used to switch a switching circuit when touched by an operator, a plurality of menu items corresponding to a plurality of function menus are displayable on the display unit, and a predetermined function menu is started and/or selected by operating the input devices provided at a position corresponding to a predetermined menu item displayed on the display unit, a predetermined function menu can be displayed by operating the input devices disposed at sections of the frame corresponding to the predetermined menu item. In this way, operability is improved.

Since a plurality of inputs is possible by only operating the operation device and the display unit does not need to be touched, the display unit does not become dirty and, thus, images can be clearly displayed on the display unit.

Since the input devices having predetermined dimensions and thicknesses are partially embedded in the frame and operation surfaces provided on the surfaces of the input devices are surrounded by guide protrusions having a predetermined height, the operator can operate the input device by sensing their finger touching the guide protrusion, and, thus, operability is excellent.

Since the menu item displayed on the display unit includes icons displayed close to the outer periphery of the display unit and in the vicinity of at least one of the input devices provided on the frame and a menu list corresponding to function menus is displayed on the display unit by operating at least one of the input devices provided in the vicinity of the predetermined icons so as to start up the predetermined function menu corresponding to a predetermined icon, input mistakes can be prevented.

Since a predetermined menu is selected from the menu list by operating at least one of the input devices in the vicinity of the predetermined icon again after the menu list is displayed, operability is excellent.

Since the frame has a rectangular shape, the input devices provided on the frame are long and are disposed along at least two sides of the frame adjacent and orthogonal to each other, the plurality of menu items displayed on the display unit include a displayed list of the function menus aligned along the X direction and the Y direction of the display unit, and a predetermined function menu is selected from the plurality of function menus in the displayed list by operating at least two of the input devices, which corresponding to a predetermined menu item, in the list display in the X direction and the Y direction, a predetermined menu item can be easily selected from the menu list displayed on the display unit and, thus, operability is excellent.

Since the display size of the function menus included in the displayed list displayed on the display unit is adjustable by operating the input devices, a plurality of inputs can be carried out with a small number of input devices. In this way, the number of components can be reduced.

### BRIEF DESCRIPTION OF THE DRAWINGS

FIG. 1 is a plan view illustrating a first screen displayed on a display unit of a display apparatus with input devices according to an embodiment of the present invention;

FIG. 2 is a plan view illustrating a second screen displayed on a display unit of a display apparatus with input devices according to an embodiment of the present invention;

FIG. 3 is a plan view illustrating a third screen displayed on a display unit of a display apparatus with input devices according to an embodiment of the present invention;

FIG. 4 is a plan view illustrating a fourth screen displayed on a display unit of a display apparatus with input devices according to an embodiment of the present invention;

FIG. 5 is a perspective view illustrating a known display apparatus with input devices;

FIG. 6 illustrates a main menu itemed on a display unit of the known display apparatus with input devices; and

FIG. 7 illustrates an adjustment screen displayed on the display unit of the known display apparatus with input devices.

### DESCRIPTION OF THE PREFERRED EMBODIMENTS

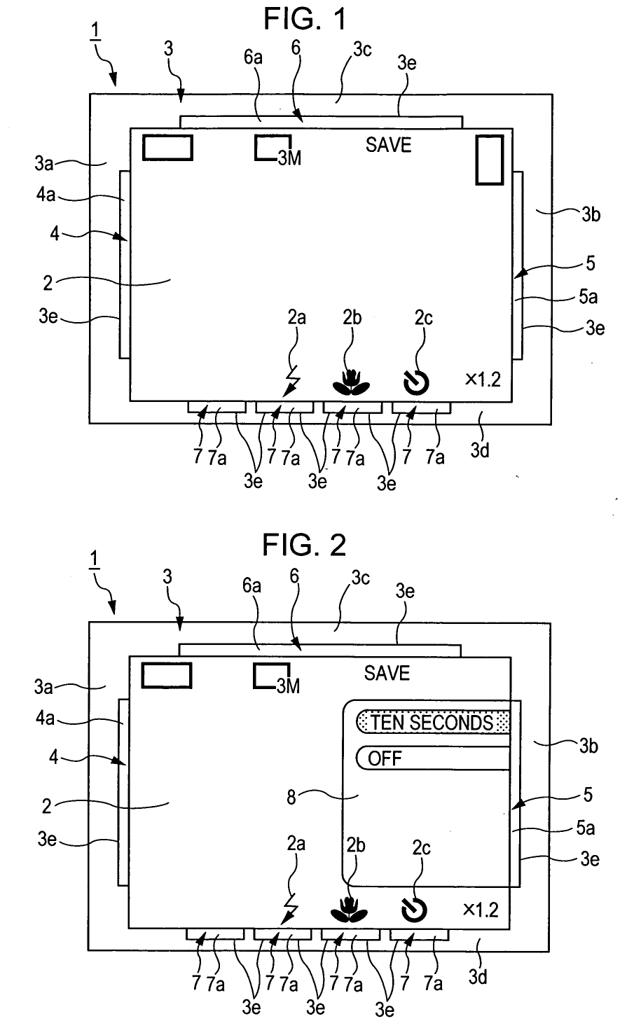

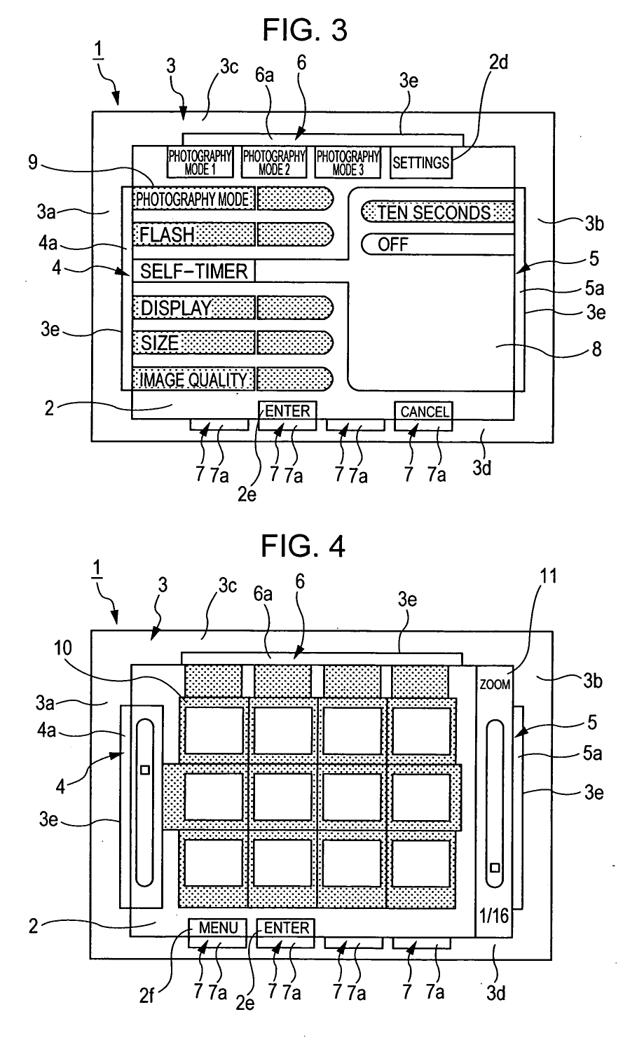

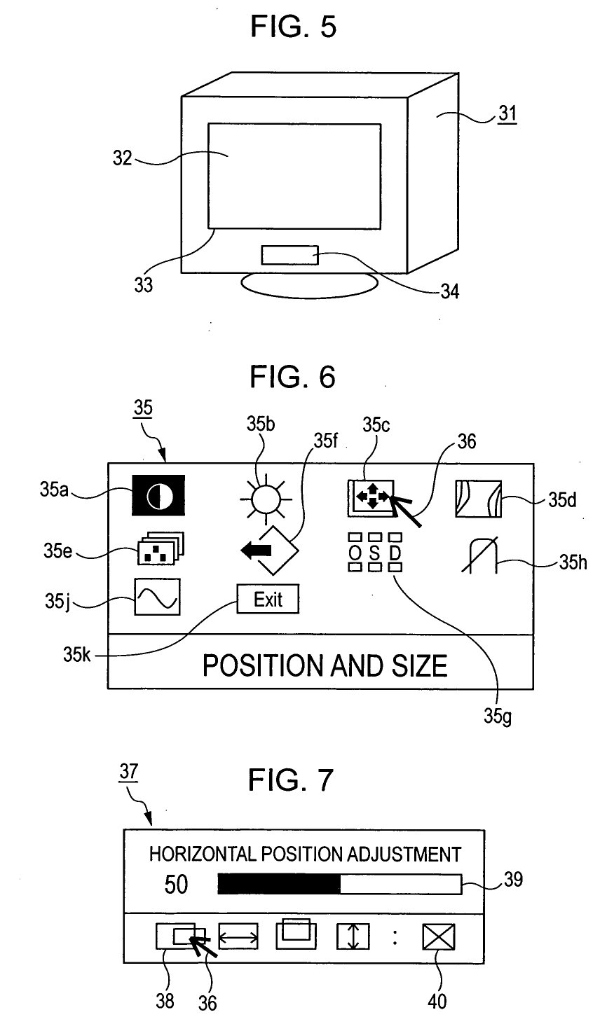

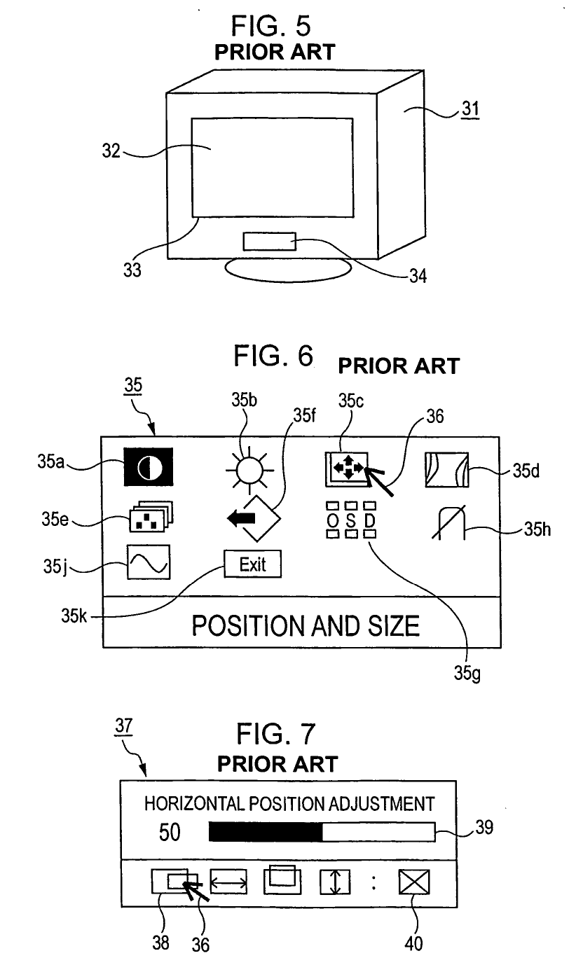

A display apparatus with input devices according to an embodiment of the present invention will be described below with reference to the drawings. FIG. 1 is a plan view illustrating a first screen displayed on a display unit of a display apparatus with input devices according to an embodiment of the present invention. FIG. 2 is a plan view illustrating a second screen displayed on a display unit of a display apparatus with input devices according to an embodiment of the present invention. FIG. 3 is a plan view illustrating a third screen displayed on a display unit of a display apparatus with input devices according to an embodiment of the present invention. FIG. 4 is a plan view illustrating a fourth screen displayed on a display unit of a display apparatus with input devices according to an embodiment of the present invention.

A case in which a display apparatus 1 with input devices according to an embodiment of the present invention is applied to a portable digital cameral will be described. A display unit 2 including a liquid crystal display is disposed, on the side opposite to the digital cameral lens. A frame 3 having a predetermined width surrounds the periphery of the display unit 2.

As shown in the drawings, the left and right areas of the frame 3 are defined as a left section 3a and a right section 3b, respectively, and are disposed opposite to each other, whereas the upper and lower areas of the frame 3 are defined as an upper section 3c and a lower section 3d and are disposed opposite to each other.

In the frame 3, long first input device 4, second input device 5, and third input device 6 are disposed in the left section 3a, the right section 3b, the upper section 3c, respectively, and four fourth input devices 7, which are shorter than the first to third input devices 4, 5, and 6, are disposed in the lower section 3d with equal intervals between each other.

The first to fourth input devices 4, 5, 6, and 7 have smooth operation surfaces 4a, 5a, 6a, and 7a, respectively. The operation surfaces 4a, 5a, 6a, and 7a are exposed from the surface of the frame 3.

When the operator lightly touches any one of the operation surfaces 4a, 5a, 6a, and 7a, the inner switching circuit is switched and predetermined coordinates can be input.

The switching circuit, for example, is constituted of X electrodes and Y electrodes arranged in a matrix (not shown in the drawings). When the operator's finger touching any one of the operation surfaces 4a, 5a, 6a, and 7a, the electric capacitance between the finger and the X and Y electrodes changes. Coordinates that correspond to this change in capacitance are input.

Instead, the operator may slide their finger on and in contact with any one of the operation surfaces 4a, 5a, 6a, and 7a, along the longitudinal direction, so as to change the hierarchy level of a function menu displayed on the display unit 2.

Guide protrusions 3e having a predetermined height are provided around the operation surfaces 4a, 5a, 6a, and 7a, which are exposed from the surface of the frame 3.

In other words, the input devices 4, 5, 6, and 7 are surrounded by the guide protrusions 3e having a predetermined height.

Accordingly, the input operation by the input devices 4, 5, 6, and 7 does not have to be visually confirmed since the input operation can be sensed by touching the guide protrusions 3e.

Next the operation of the display apparatus 1 with the input devices 4 to 7 is described with reference to the drawings. When the display apparatus 1 constituting a digital camera is in a photography mode, the display unit 2 displays a first screen that is capable of displaying an image captured by a charge-coupled device (CCD) (imaging device).

On the first screen in the photography mode, a plurality of icons representing menu items are displayed in the lower area, close the periphery of the display unit 2 in the vicinity of the fourth input devices 7 provided at the lower section 3d of the frame 3.

The plurality of icons are, for example, a first icon 2a, a second icon 2b, and a third icon 2c corresponding to a flash mode, a close-up mode, and a self-timer mode, respectively, which are items of a function menu for the digital camera.

The operation of the third icon 2C corresponding to the self-timer mode will be described as an example. When carrying out self-timer photography, when the photographer's finger touches an operation surface 7a of the rightmost fourth input device 7, as shown in the drawing, corresponding to the third icon 2c, a second screen, such as that shown in FIG. 2, is displayed and a first menu list 8 that is the self-timer menu corresponding to the third icon 2c is displayed.

When the first menu list 8 is displayed, the first menu list 8 is set to OFF. At this time, if an operation surface 5a of the second input device 5 corresponding to the first menu list 8 is touched, the switching circuit of the second input device 5 is switched, and a predetermined menu item, e.g., ten-second self-timer, included in the first menu list 8 is selected.

In other words, by operating the input devices 5 and 7, a predetermined function menu item may be started-up or selected.

If the fourth input device 7, which is the leftmost input device among the four fourth input devices shown in the drawings, is touched after selecting the menu item corresponding to the ten-second self-timer, the ten-second self-timer menu item is entered and set and the second screen is changed to the first screen so that the image to be photographed is displayed in a large size.

In other words, by repeatedly operating the same input device 7, a plurality of inputs, such as starting, selecting, and entering a function menu item, is possible. Thus, the display apparatus 1 with input devices 4 to 7 can be easily operated.

If the photographer presses the shutter button after the first screen is displayed again on the display unit 2, the shutter is operated ten seconds later so as to capture the image displayed on the display unit 2.

In case the first to third icons 2a, 2b, and 2c are not used, by operating buttons other than the first to fourth input devices 4 to 7, the display unit 2 displays a third screen including a second menu list 9 corresponding to a plurality of function menu items, as shown in FIG. 3.

To select one of the function menu items, such as a self-timer menu item, included in the second menu list 9, the first input device 4 in the vicinity of the menu item, self-timer, is lightly touched by the operator to display the first menu list 8, which is the same menu list shown in FIG. 2, on the right of the display unit 2.

Then, to set the time for the self-timer to, for example, ten seconds, the second input device 5 in the vicinity of the displayed 10-second menu item is lightly touched and then the third input device 6 in the vicinity of a setting mode indication 2d displayed in the upper area of the display unit 2 is lightly touched.

By touching the second left input device 7, as shown in the drawing, in the vicinity of an enter mode indication 2e displayed in the lower area of the display unit 2 after setting the self-timer to ten seconds, the time of the self-timer is set to ten seconds and the second screen is changed back to the first screen so that the image to be photographed is displayed in a large size.

To turn off the self-timer function, the second input device 5 in the vicinity of the OFF menu item displayed in the first menu list 8 is touched.

When the self-timer function is turned off, the shutter is operated immediately after the shutter button is pressed.

Moreover, the operator can scroll the second menu list 9 upward or downward by sliding their finger placed on the operation surface 4a of the first input device 4 upward or downward so that function menu items other than those illustrated in FIG. 3 are displayed on the display unit 2.

To view previously captured images, an operation button (not shown in the drawing) other than the first to fourth input devices 4 to 7 are operated so that a plurality of previously captured images are displayed in a displayed list 10, i.e., displayed menu, where the images are arranged along the X and Y directions, as on the display unit 2 in shown in FIG. 4.

To print out a predetermined image (menu item) included in the displayed list 10 with a printer, the predetermined image can be selected by touching the first input device 4 and the fourth input device 7 that correspond to the predetermined image and that are disposed along at least two orthogonal sides (left section 3a and upper section 3c) along the X and Y directions of the frame 3.

After selecting the predetermined image, by operating the operation surface 7a of the fourth input device 7 corresponding to the enter mode indication 2e provided the vicinity of the enter mode indication 2e, the selected predetermined image is entered and set so that the image to be photographed is displayed in a large size on the display unit 2.

Then, the selected predetermined image can be printed with a printer. In an area of the display unit 2 in the vicinity of the second input device 5, as shown in FIG. 4, a zooming icon 11 that allows the image in the displayed list 10 to be zoomed in or zoomed out is displayed.

When the photographer's finger is placed on the operation surface 5a of the second input device 5 and, for example, slid upwards, as shown in the drawing, the size of images in the displayed list 10 is increased, whereas, if the finger is slid downwards, the size of the images is decreased. For example, as shown in FIG. 4, the displayed list 10 displayed on the display unit 2 includes 16 images. By zooming in on these images, the number of images included in the displayed list 10 will be decreased to nine images, four images, or one image so that the size of each of images is increased.

By operating the fourth input device 7 in the vicinity of a menu mode indication 2f corresponding to the menu mode indication 2f, as shown in FIG. 4, a menu for processing or deleting the selected image can be displayed.

Such a display apparatus with input devices according to this embodiment of the present invention is capable of clearly displaying images on the display unit 2 by preventing the display unit 2 from becoming dirty since the display unit 2 does not have to be touched for input.

Since a cursor is not displayed on the display unit 2, a complicated operation of moving a cursor in the X and Y directions is not required. In this way, operation is simple and easy.

According to this embodiment according to the present invention, the input devices 4 to 7 were disposed in all sections 3a to 3d of the frame 3. However, the input devices only need to be provided on the frame 3 at at least two adjacent sides orthogonal to each other in the X and Y directions (for example, on the right section 3b and the upper section 3c in FIG. 1).

The input devices 3 to 7 according to the above-described embodiments are capacitance switches. However, the input devices 3 to 7 may be membrane switches having a plurality of moving contacts and a plurality of fixed contacts.

1. A display apparatus with input devices, comprising:
a display unit including a liquid crystal display; and
a frame surrounding a periphery of the display unit, wherein,
the input devices are configured used to switch a switching circuit when touched by an operator, the input devices being disposed on the frame,
a plurality of menu items corresponding to a plurality of function menus are displayable on the display unit, and
a predetermined function menu is at least one of started or selected by operating the input devices provided at a position corresponding to a predetermined menu item displayed on the display unit.

2. The display apparatus with input devices according to claim 1, wherein.
the input devices have predetermined widths and thicknesses and are partially embedded in the frame, and
operation surfaces provided on surfaces of the input devices are surrounded by guide protrusions having a predetermined height.

3. The display apparatus with input devices according to claim 1, wherein,
the menu items displayed on the display unit includes icons displayed close to an outer periphery of the display unit and in the vicinity of at least one of the input devices provided on the frame, and
a menu list corresponding to function menus is displayed on the display unit by operating at least one of the input devices provided in the vicinity of the predetermined icons so as to start up the predetermined function menu corresponding to a predetermined icon.

4. The display apparatus with input devices according to claim 3, wherein a predetermined menu is selected from the menu list by operating at least one of the input devices in the vicinity of the predetermined icon again after the menu list is displayed.

5. The display apparatus with input devices according to claim 1, wherein,
the frame has a rectangular shape,
the input devices provided on the frame are long and are disposed along at least two sides of the frame adjacent and orthogonal to each other in the X direction and Y direction,
the plurality of menu items displayed on the display unit include a displayed list of the function menus aligned along the X direction and the Y direction of the display unit, and
a predetermined function menu is selected from the plurality of function menus by operating at least two of the input devices in the list display in the X direction and the Y direction, the input devices corresponding to a predetermined menu item included in the displayed list.

6. The display apparatus with input devices according to claim 5, wherein a display size of the function menus included in the displayed list displayed on the display unit is adjustable by operating the input devices.
